(19) United States
(12) Patent Application Publication
(10) Pub. No.: US 2026/0058584 A1
(43) Pub. Date: Feb. 26, 2026

(54) STATIONARY POWER STORAGE APPARATUS, CONTROL METHOD THEREFOR AND NON-TRANSITORY COMPUTER-READABLE STORAGE MEDIUM

(71) Applicant: TOYOTA JIDOSHA KABUSHIKI KAISHA, Toyota-shi (JP)

(72) Inventor: Natsuki TANAKA, Nagoya-shi (JP)

(73) Assignee: TOYOTA JIDOSHA KABUSHIKI KAISHA, Toyota-shi (JP)

(21) Appl. No.: 19/278,262

(22) Filed: Jul. 23, 2025

(30) Foreign Application Priority Data
Aug. 20, 2024 (JP) 2024-138734

(51) Int. Cl. H02P 23/14; H01M 10/42; H01M 50/204; H01M 50/251; H02P 25/06

(52) U.S. Cl. CPC H02P 23/14; H01M 10/425; H01M 50/204; H01M 50/251; H02P 25/06; H01M 2220/10

(57) ABSTRACT

The exterior cover includes a movable part and a fixed part sandwiching a plurality of modules therebetween, in plan view. The movable part is supported by the fixed part so as to be rotatable about a horizontally-extending rotational axis. A linear actuator is coupled to the movable part and the fixed part to thereby bring a lower edge of the movable part to a position closer to the fixed part or a position receding from the fixed part. A control circuit is configured to control two linear actuators so that the lower edge of the movable part is brought to a position receding from the fixed part when it is determined that there is a sign of overturning of the stationary power storage apparatus.

### CROSS REFERENCE TO RELATED APPLICATIONS

This application is based upon and claims the benefit of priority from Japanese patent application No. 2024-138734, filed on Aug. 20, 2024, the disclosure of which is incorporated herein in its entirety by reference.

### BACKGROUND

The present disclosure relates to a stationary power storage apparatus and a control method therefor.

Patent Literature 1 discloses a power supply device in which three battery stacks, each of which is formed by stacking a plurality of batteries and holding them by a bracket, are aligned in the same direction in which the electrodes are taken out. This type of power supply device is configured so that even in a case where overturning of the power supply device occurs, it easily overturn in a direction opposite the direction in which the electrodes are taken out to thereby prevent the electrodes of the power supply device from colliding with the installation surface thereof. Patent Literature 1 further discloses an auxiliary member extending from the electrode take-out side of the bracket to the installation surface. The auxiliary member makes it difficult for the power supply device to overturn in the direction in which the electrodes are taken out.

[Patent Literature 1] Japanese Unexamined Patent Application Publication No. 2014-032900

### SUMMARY

It is an object of the present disclosure to provide a technique for preventing a stationary power storage apparatus from overturning while compactly configuring the compact stationary power storage apparatus.

A stationary power storage apparatus, including:
at least one module configured of a plurality of cells;
a case for housing the at least one module;
an inclination sensor adapted to detect an angle of inclination of the at least one module; a linear actuator; and
a control circuit configured to determine whether there is a sign of overturning of the stationary power storage apparatus based on a detection result of the inclination sensor, in which
   the case includes a movable part and a fixed part sandwiching the at least one module therebetween, in plan view,
   the movable part is supported by the fixed part so as to be rotatable about a horizontally-extending rotational axis,
   the linear actuator is coupled to the movable part and the fixed part to thereby bring a lower edge of the movable part to a position closer to the fixed part or a position receding from the fixed part, and
   the control circuit is configured to control the linear actuator so that the lower edge of the movable part is brought to a position receding from the fixed part when it is determined that there is a sign of overturning of the stationary power storage apparatus.

According to the above configuration, it is possible to prevent a stationary power storage apparatus from overturning while compactly configuring the stationary power storage apparatus. Moreover, since an external force acting on the movable part is received by the fixed part via the linear actuator, damage to the plurality of modules can be suppressed.

Moreover, rotational axis is provided at an upper edge of the movable part. According to the above configuration, it is possible to bring the lower edge of the movable part to a position receding largely from the fixed part.

The linear actuator is coupled to the lower edge of the movable part. According to the above configuration, an external force acting on the movable part can be efficiently received by the linear actuator.

Also, the control circuit is configured to determine whether there is a sign of overturning of the stationary power storage apparatus based on a result of comparison between an angle of inclination of the at least one module and a predetermined value. According to the above configuration, it is possible to determine whether there is a sign of overturning of a stationary power storage apparatus by a simple comparison operation.

Also provided is a control method for a stationary power storage apparatus that includes:
at least one module configured of a plurality of cells;
a case for housing the at least one module;
an inclination sensor adapted to detect an angle of inclination of the at least one module; and
a linear actuator, in which
   the case includes a movable part and a fixed part sandwiching the at least one module therebetween, in plan view,
   the movable part is supported by the fixed part so as to be rotatable about a horizontally-extending rotational axis, and
   the linear actuator is coupled to the movable part and the fixed part to thereby bring a lower edge of movable part to a position closer to the fixed part or a position receding from the fixed part,
      the control method for the stationary power storage apparatus, including:
determining whether there is a sign of overturning of the stationary power storage apparatus; and
controlling, based on a result of the determination, the linear actuator so that the lower edge of the movable part is brought to a position receding from the fixed part.

According to the above method, it is possible to prevent a stationary power storage apparatus from overturning while compactly configuring the stationary power storage apparatus.

According to the present disclosure, it is possible to prevent a stationary power storage apparatus from overturning while compactly configuring the stationary power storage apparatus. Moreover, since an external force acting on the movable part is received by the fixed part via the linear actuator, damage to the at least one module can be suppressed.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a stationary power storage apparatus;

FIG. 2 is a plan view of a stationary power storage apparatus;

FIG. 3 is a view showing an open state of a movable part of a stationary power storage apparatus;

FIG. 4 is a functional block diagram of a stationary power storage apparatus; and

FIG. 5 is a flow of control of a stationary power storage apparatus.

### DESCRIPTION OF EMBODIMENTS

Hereinafter, the present disclosure will be described through the embodiments of the disclosure, but the claimed disclosure is not limited to the following embodiments. In addition, not all of the structures described in the embodiments are necessarily essential as means for solving the problem. For clarification of the explanation, the following descriptions and drawings are omitted and simplified as appropriate. In each of the drawings, the same reference symbols denote the same elements/components, and duplicate explanations are omitted, as necessary.

In the following embodiments, when it is necessary for the sake of convenience, the description is divided into a plurality of sections or embodiments, and an embodiment is related to a part or all of the rest of the embodiments in a form of a modified example, an application example, detailed explanation, or supplementary explanation and they are not unrelated to each other, unless explicitly stated otherwise. In the following embodiments, when referring to the number of elements, etc. (including numbers, values, quantities, ranges, etc.), unless specifically stated otherwise or is obvious that the number should be a limited number in principle, such number should not be limited to the specific number given in the embodiments.

Furthermore, in the following embodiments, the components (including the operation steps, etc.) are not necessarily essential unless explicitly stated otherwise or is obvious that they are essential in principle. Similarly, in the following embodiments, when referring to the shapes or positional relationships of the components, etc., unless specifically stated otherwise or is obviously not applicable in principle, they include those substantially approximate or similar to the given shape, etc. This is also applicable to the aforementioned numbers, etc. (including numbers, numbers, quantities, and ranges).

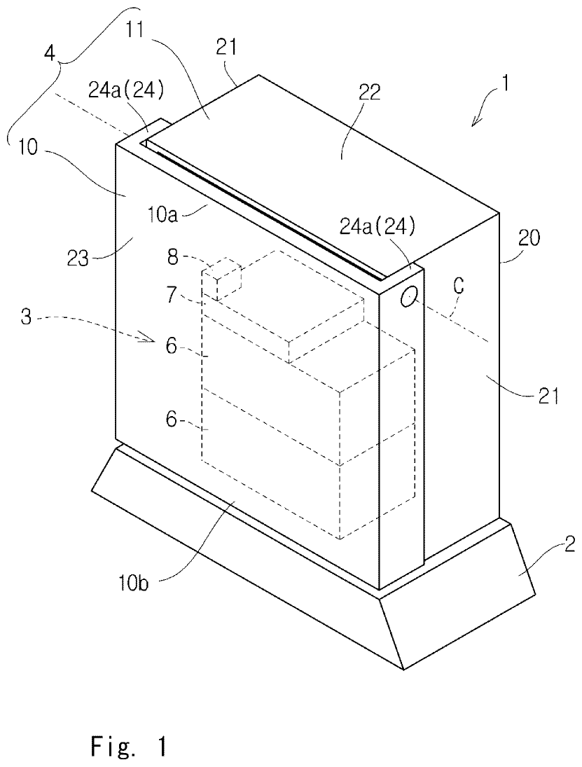

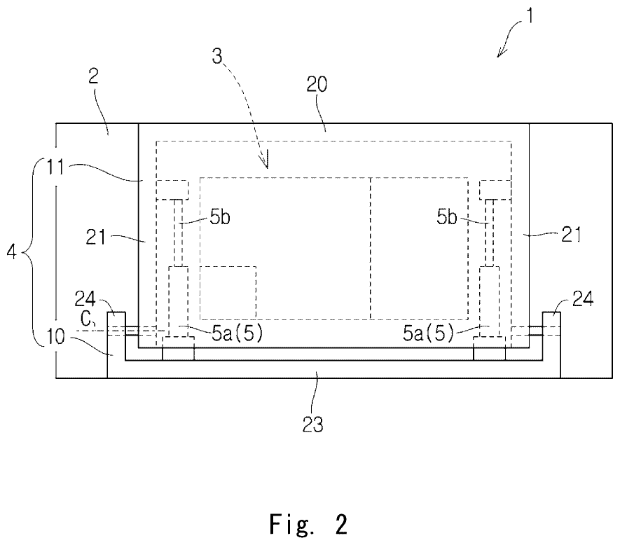

A stationary power storage apparatus 1 will be described below with reference to FIGS. 1 to 5. The stationary power storage apparatus 1 is a power storage apparatus typically installed in a house. FIG. 1 is a perspective view of the stationary power storage apparatus 1. FIG. 2 is a plan view of the stationary power storage apparatus 1. As shown in FIGS. 1 and 2, the stationary power storage apparatus 1 includes a foundation block 2, a pack 3, an exterior cover 4, and two linear actuators 5.

The pack 3 is integrally configured of a plurality of modules 6, a control circuit 7, and an inclination sensor 8.

In this embodiment, a plurality of modules 6 refer to two modules 6. The two modules 6 are vertically stacked. Alternatively, however, the two modules 6 may be horizontally aligned. Each module 6 is configured of a plurality of cells. Each cell is typically a lithium ion cell and is formed into a cylindrical, square, or pouch shape. The plurality of modules 6 are mechanically coupled to each other by a frame (not shown) and electrically coupled to each other by a bus bar (not shown).

The inclination sensor 8 detects an angle of inclination of the plurality of modules 6. The inclination sensor 8 is typically a triaxial acceleration sensor.

Based on the detection result of the inclination sensor 8, the control circuit 7 determines whether there is a sign of overturning of the stationary power storage apparatus 1. The control circuit 7 controls the two linear actuators 5 to prevent the overturning of the stationary power storage apparatus 1 when it is determine that there is a sign of the overturning of the stationary power storage apparatus 1.

As described above, the pack 3 includes the plurality of modules 6, the control circuit 7, and the inclination sensor 8. At this time, the plurality of modules 6, the control circuit 7, and the inclination sensor 8 may be housed in a container (not shown).

The exterior cover 4 houses the pack 3. The exterior cover 4 is a specific example of a case. The exterior cover 4 is configured of a movable part 10 and a fixed part 11.

The fixed part 11 includes a rear cover 20 covering the rear of the pack 3, two side covers 21 covering the two sides of the pack 3, and a top cover 22 covering the top of the pack 3.

The movable part 10 includes a front cover 23 covering the front of the pack 3, and two connection parts 24 partially overlapping the two side covers 21 of the fixed part 11, respectively.

The movable part 10 is supported by the fixed part 11 so as to be rotatable about a horizontally-extending rotational axis C (rotational axis). Specifically, the rotational axis C is provided at an upper edge 10a of the movable part 10. The rotational axis C is provided in a region where one of the two side covers 21 overlaps the corresponding connection part 24. Therefore, the rotational axis C is provided at an upper edge 24a of the connection part 24. With this configuration, when the movable part 10 rotates about the rotational axis C, a lower edge 10b of the movable part 10 is brought to a position closer to the fixed part 11 or a position receding from the fixed part 11. Typically, a cylindrical rotational shaft (rotational shaft) projecting outward from the fixed part 11 along the rotational axis C is provided, and the rotational shaft is inserted into a shaft through hole provided in the movable part 10.

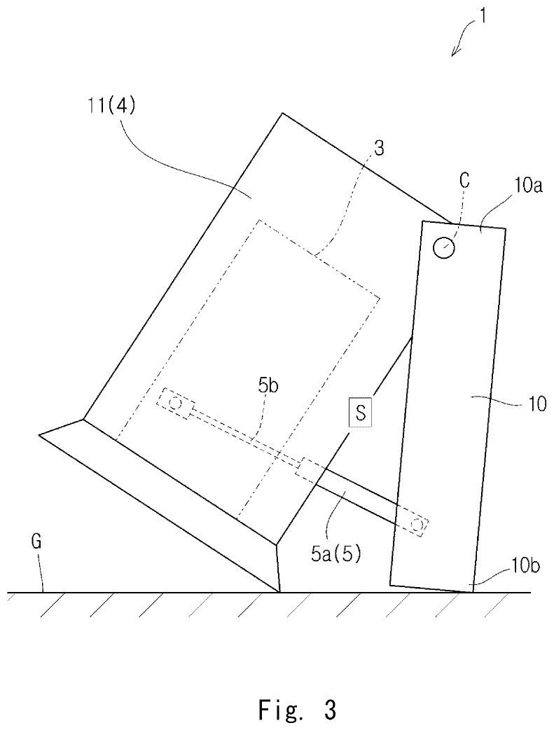

As shown in FIG. 2, the two linear actuators 5 are disposed in the exterior cover 4. Each linear actuator 5 is configured of an actuator main body 5a and a rod 5b slidable with respect to the actuator main body 5a. The actuator main body 5a moves the rod 5b forward and backward with respect to the actuator main body 5a by pneumatic pressure, hydraulic pressure, or electric power based on a control signal from the control circuit 7. Each linear actuator 5 is coupled to the movable part 10 and the fixed part 11. As an example, the actuator main body 5a is rotatably coupled to the front cover 23 of the movable part 10, and the rod 5b is rotatably coupled to the corresponding one of the side covers 21 of the fixed part 11. With the above configuration, when the rod 5b advances from the actuator main body 5a based on the control signal from the control circuit 7, the movable part 10 rotates with respect to the fixed part 11 so that the lower edge 10b of the movable part 10 is brought to a position receding from the fixed part 11, as shown in FIG. 3. As a result, the movable part 10 changes from the closed state shown in FIG. 2 to the open state shown in FIG. 3.

Therefore, when the control circuit 7 determines that there is a sign of overturning of the stationary power storage apparatus 1 based on the detection result of the inclination sensor 8, it controls the two linear actuators 5 so that the lower edge 10b of the movable part 10 is brought to a position receding from the fixed part 11. As a result, before the stationary power storage apparatus 1 overturns, the lower edge 10b of the movable part 10 is brought to a position in contact with the installation ground G of the stationary power storage apparatus 1, whereby the stationary power storage apparatus 1 is prevented from overturning. In addition, since a large space S is formed between the pack 3 and the movable part 10 in this configuration, even in the case where the movable part 10 is deformed to somewhat be dented, the pack 3 is not damaged.

Furthermore, as shown in FIG. 2, the movable part 10 and the fixed part 11 are connected by the two linear actuators 5. Therefore, when an external force acts on the movable part 10, the external force is received by the fixed part 11 via the two linear actuators 5 and then absorbed due to the deformation of the movable part 10 and the fixed part 11. As a result, the pack 3 is not damaged.

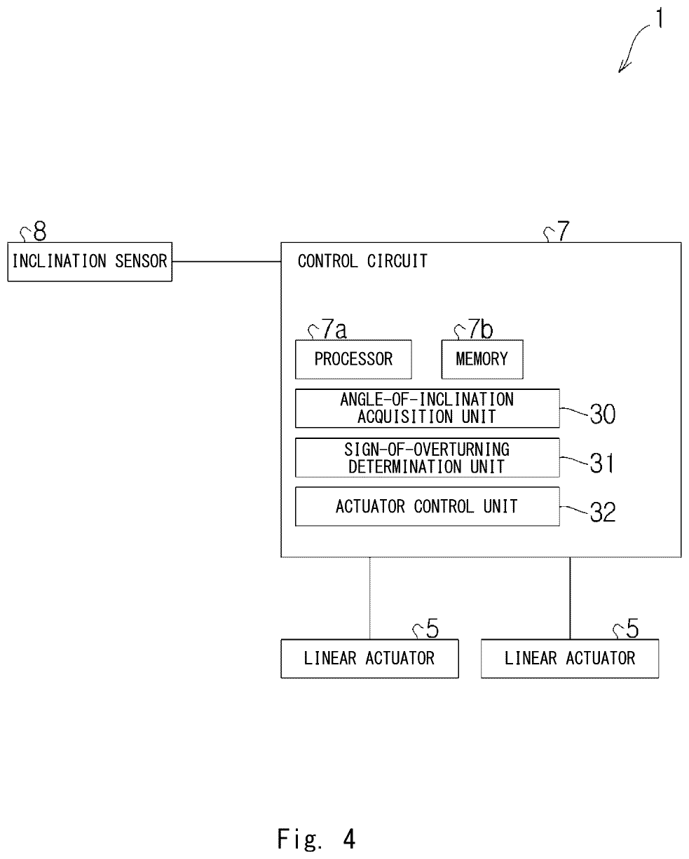

FIG. 4 is a block diagram of the stationary power storage apparatus 1. As shown in FIG. 4, the control circuit 7 includes a processor 7a and a memory 7b. The processor 7a can access the memory 7b. The processor 7a reads and executes a program stored in the memory 7b.

Thus, the processor 7a makes hardware such as the processor 7a and the memory 7b function as an angle-of-inclination acquisition unit 30, a sign-of-overturning determination unit 31, and an actuator control unit 32. The processor 7a may be an FPGA (Field Programmable Gate Array), ASIC (Application Specific Integrated Circuit), or CPLD (Complex Programmable Logic Device).

The angle-of-inclination acquisition unit 30 obtains an angle signal indicating an angle of inclination of the pack 3 from the inclination sensor 8.

Based on the angle signal acquired by the angle-of-inclination acquisition unit 30, the sign-of-overturning determination unit 31 determines whether there is a sign of overturning of the stationary power storage apparatus 1. Specifically, the sign-of-overturning determination unit 31 compares an angle of inclination of the pack 3 with a predetermined value, and determines whether there is a sign of overturning of the stationary power storage apparatus 1 based on the result of the comparison (hereinafter referred to as a comparison result). More specifically, the sign-of-overturning determination unit 31 compares an angle of inclination of the pack 3 with the predetermined value, and when the angle of inclination of the pack 3 exceeds the predetermined value, determines that there is a sign of overturning of the stationary power storage apparatus 1. The predetermined value is typically from 10 degrees to 25 degrees, but is not limited thereto.

The actuator control unit 32 controls the two linear actuators 5 so that the lower edge 10b of the movable part 10 is brought to a position receding from the fixed part 11 in the case where the sign-of-overturning determination unit 31 determines that there is a sign of overturning of the stationary power storage apparatus 1. Specifically, when the sign-of-overturning determination unit 31 determines that there is a sign of overturning of the stationary power storage apparatus 1, the actuator control unit 32 outputs, to the two linear actuators 5, an advance control signal for causing the rod 5b to advance from the actuator main body 5a. Thus, as shown in FIG. 3, the movable part 10 protrudes before the stationary power storage apparatus 1 overturns, thereby preventing the stationary power storage apparatus 1 from overturning.

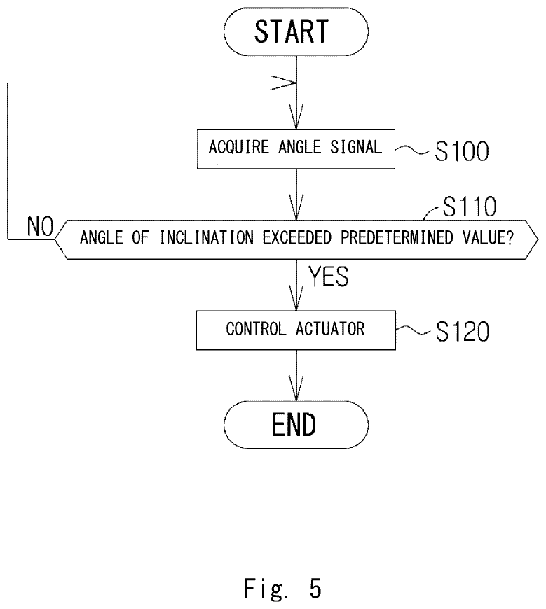

Next, the operation of the stationary power storage apparatus 1 will be described with reference to FIG. 5. First, the angle-of-inclination acquisition unit 30 acquires an angle signal indicating an angle of inclination of the pack 3 from the inclination sensor 8 (S100). Next, the sign-of-overturning determination unit 31 compares the angle of inclination of the pack 3 with a predetermined value to determine whether there is a sign of overturning of the stationary power storage apparatus 1 (S110). Specifically, the sign-of-overturning determination unit 31 determines whether the angle of inclination of the pack 3 exceeds the predetermined value (S110). In the case where the angle of inclination of the pack 3 does not exceed the predetermined value (S110: NO), the sign-of-overturning determination unit 31 determines that there is no sign of overturning of the stationary power storage apparatus 1, and the process returns to Step S100. On the other hand, in the case where the angle of inclination of the pack 3 exceeds the predetermined value (S110: YES), the sign-of-overturning determination unit 31 determines that there is a sign of overturning of the stationary power storage apparatus 1, performs the next step, i.e., Step S120. In Step S120, the actuator control unit 32 controls the two linear actuators 5 so that the lower edge 10b of the movable part 10 is brought to a position receding from the fixed part 11 (S120).

A preferred embodiment of the present disclosure has been described above. The above-described embodiment has the following features.

The stationary power storage apparatus 1 includes a plurality of modules 6 which is configured of a plurality of cells, the exterior cover 4 (case) for housing the plurality of modules 6, the inclination sensor 8 adapted to detect an angle of inclination of the plurality of modules 6, the two linear actuators 5, and the control circuit 7 configured to determine whether there is a sign of overturning of the stationary power storage apparatus 1 based on the detection result of the inclination sensor 8. The exterior cover 4 includes the movable part 10 and the fixed part 11 sandwiching the plurality of modules 6 therebetween, in plan view. The movable part 10 is supported by the fixed part 11 so as to be rotatable about the horizontally-extending rotational axis C. The linear actuator 5 is coupled to the movable part 10 and the fixed part 11 to thereby bring the lower edge 10b of the movable part 10 to a position closer to the fixed part 11 or a position receding from the fixed part 11. The control circuit 7 is configured to control the two linear actuators 5 so that the lower edge 10b of the movable part 10 is brought to a position receding from the fixed part 11 when it is determined that there is a sign of the stationary power storage apparatus 1 overturning. With the above configuration, it is possible to prevent the stationary power storage apparatus 1 from overturning while compactly configuring the stationary power storage apparatus 1. In addition, since the external force acting on the movable part 10 is received by the fixed part 11 via the two linear actuators 5, damage to the plurality of modules 6 can be suppressed.

In other words, since the stationary power storage apparatus 1 does not have a member corresponding to the auxiliary member of Patent Literature 1, it can be said that the stationary power storage apparatus 1 compactly configured.

Note that, instead of including the plurality of modules 6, the stationary power storage apparatus 1 may include only one module 6. The stationary power storage apparatus 1 may include only one linear actuator 5 instead of including two linear actuators 5.

As shown in FIG. 1, the rotational axis C is provided at the upper edge 10a of the movable part 10. According to the above configuration, as shown in FIG. 3, in the case where the movable part 10 is opened, the lower edge 10b of the movable part 10 can be brought to a position receding largely from the fixed part 11.

Also, as shown in FIG. 3, the two linear actuators 5 is coupled to the lower edge 10b of the movable part 10. According to the above configuration, the external force acting on the movable part 10 can be efficiently received by the two linear actuators 5.

Furthermore, based on the result of comparison between the angle of inclination of the plurality of modules 6 and the predetermined value, the control circuit 7 determines whether there is a sign of overturning of the stationary power storage apparatus 1. According to the above configuration, it is possible to determine whether there is a sign of overturning of the stationary power storage apparatus 1 by a simple comparison calculation.

The control method for the stationary power storage apparatus 1 includes determining whether there is a sign of overturning of the stationary power storage apparatus 1 (S110), and controlling the two linear actuators 5 so that the lower edge 10b of the movable part 10 is brought to a position receding from the fixed part 11 based on the result of the determination (S120). According to the above configuration, it is possible to prevent the stationary power storage apparatus 1 from overturning while compactly configuring the stationary power storage apparatus 1.

Although the disclosure made by the present inventors has been specifically described based on the embodiments described above, it is needless to say that the present disclosure is not limited to the embodiments described above and that various modifications can be made within the scope not to deviate from the gist of the present disclosure.

The program includes instructions (or software code) for causing the computer to perform one or more functions described in the embodiments when read into the computer. The program may be stored in a non-transitory computer-readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A stationary power storage apparatus, comprising:
at least one module configured of a plurality of cells;
a case for housing the at least one module;
an inclination sensor adapted to detect an angle of inclination of the at least one module;
a linear actuator; and
a control circuit configured to determine whether there is a sign of overturning of the stationary power storage apparatus based on a detection result of the inclination sensor, wherein
the case includes a movable part and a fixed part sandwiching the at least one module therebetween, in plan view,
the movable part is supported by the fixed part so as to be rotatable about a horizontally-extending rotational axis,
the linear actuator is coupled to the movable part and the fixed part to thereby bring a lower edge of the movable part to a position closer to the fixed part or a position receding from the fixed part, and
the control circuit is configured to control the linear actuator so that the lower edge of the movable part is brought to a position receding from the fixed part when it is determined that there is a sign of overturning of the stationary power storage apparatus.

2. The stationary power storage apparatus according to claim 1, wherein the rotational axis is provided at an upper edge of the movable part.

3. The stationary power storage apparatus according to claim 1, wherein the linear actuator is coupled to the lower edge of the movable part.

4. The stationary power storage apparatus according to claim 1, wherein the control circuit is configured to determine whether there is a sign of overturning of the stationary power storage apparatus based on a result of comparison between an angle of inclination of the at least one module and a predetermined value.

5. A control method for a stationary power storage apparatus that comprises:
at least one module configured of a plurality of cells;
a case for housing the at least one module;
an inclination sensor adapted to detect an angle of inclination of the at least one module; and
a linear actuator, wherein
the case includes a movable part and a fixed part sandwiching the at least one module therebetween, in plan view,
the movable part is supported by the fixed part so as to be rotatable about a horizontally-extending rotational axis, and
the linear actuator is coupled to the movable part and the fixed part to thereby bring a lower edge of the movable part to a position closer to the fixed part or a position receding from the fixed part,
the control method for the stationary power storage apparatus, comprising:
determining whether there is a sign of overturning of the stationary power storage apparatus; and
controlling, based on a result of the determination, the linear actuator so that the lower edge of the movable part is brought to a position receding from the fixed part.

6. A non-transitory computer-readable storage medium storing a program for causing a computer to execute the computer-implemented control method according to claim 5.
